(19) United States
(12) Patent Application Publication
(10) Pub. No.: US 2022/0039583 A1
(43) Pub. Date: Feb. 10, 2022

(54) Beverage Infuser, Strainer, and Modular Container Assembly

(71) Applicant: Adrian Rivera, Whittier, CA (US)

(72) Inventor: Adrian Rivera, Whittier, CA (US)

(21) Appl. No.: 17/185,869

(22) Filed: Feb. 25, 2021

Related U.S. Application Data
(60) Provisional application No. 62/981,503, filed on Feb. 25, 2020.
(60) Provisional application No. 62/982,891, filed on Feb. 28, 2020.

(51) Int. Cl. A47J 19/00; A47J 19/06; A47J 43/07

(52) U.S. Cl. CPC A47J 19/005; A47J 43/0722; A47J 19/06

(57) ABSTRACT

A beverage strainer includes a piston and a push-rod. The piston is configured to slide within a length of a tube, or along an inner sidewall of a container. The push-rod is configured to be coupled to the piston and to be manipulated to cause the piston to slide within the length of tube. The piston includes a plurality of apertures sized to allow passage of particulate matter through the piston within the tube.

### CROSS-REFERENCE TO RELATED APPLICATIONS

This is related to, and claims priority from, co-pending U.S. Provisional application for Patent No. 62/981,503, which was filed on Feb. 25, 2020, and U.S. Provisional application for Patent No. 62/982,891, which was filed on Feb. 28, 2020, the disclosures of both of which are incorporated herein in their entireties.

### FIELD OF THE INVENTION

The invention relates to devices for making beverages and in particular to devices that separate solid matter from a blended or mixed beverage.

### BACKGROUND OF THE INVENTION

Blenders are often used to make beverages from fruit, vegetables, and other ingredients. Typically, a beverage is made by putting fruit and various other ingredients in a blender and pulverizing the ingredients until they are liquified. Often, water or other liquid is added to the mix before blending to help thin the resulting beverage. Vegetables are often added to contribute to the nutritional profile, and protein powder, collagen, and other ingredients can make the resulting beverage a more complete meal replacement.

In order to get the most nutrition from the beverage, it is best to use fresh fruits and vegetables in the beverage. In the blender, the liquid and suspendable solids in the fruits and vegetables are separated from cellulose and pulp that can't be liquified. Sometimes it is desired to mix the pulp with the beverage, resulting in a thick beverage that is often difficult to drink. Usually it is desired to remove at least some of the pulp prior to dispensing or drinking the beverage. However, it can be difficult to remove the pulp, which usually stays mixed with the beverage and must be strained. Producing a beverage that is completely free of pulp is therefore very difficult. Leaving some of the pulp, in particular pulp having no greater than a desired suspension size, is even more difficult.

Specialty blenders made specifically for juicing are available, which automatically extract the pulp as the beverage is prepared. However, these juicers typically are complex and difficult to clean, and remove all of the pulp without regard to the beverage thickness desired by the user. Further, because it is a specialty device dedicated to making juice, it must be purchased in addition to a blender if ordinary blending is desired for other applications.

Other mixers and/or containers are used to prepare beverages from ingredients including liquid and powder. For example, protein drinks can be mixed from a protein powder and a liquid such as water or milk. Container assemblies designed to be used to mix these beverages typically include a lid, so that the container can be shaken to mix the ingredients. The lid can include a covered opening through which the mixed beverage can be dispensed, or the lid can be removed after mixing so the beverage can be drunk directly from the container. Because some powders do not mix well with liquid and tend, for example, to clump rather than dissolve, the lids on some mixing containers include structures for breaking up clumps as the beverage is mixed while the container is shaken. Flavoring items can also be mixed into the beverage in this way, as long as they are provided in a form that can be dissolved in the beverage. Flavoring items that have to be infused, such as flavoring from lemons, ginger, hibiscus flower, or the like typically can't be shaken into the beverage efficiently and would have to be filtered out of the beverage when dispensing. Infusion is a process that typically takes a long time, and is impractical for a beverage that is to be drunk right away.

It would be advantageous to provide a blender having an easy-to-use implement configured to remove pulp from a blended beverage. It would be particularly advantageous if the blender can also be used as a conventional blender, and can selectively remove only some of the pulp from a blended beverage. It would also be beneficial to provide a blender accessory that can be used with a conventional blender to provide these advantageous features. It would also be beneficial to be able to provide similar functionality to a shaker container, or to any type of container that can hold a beverage, and to be able to provide infusion capability in the same container. A universal container for use in blending, shaking, infusing, dispensing, and drinking a beverage would also be quite useful.

### BRIEF DESCRIPTION OF THE INVENTION

According to an aspect of the invention, a beverage strainer includes a piston and a push-rod. The piston is configured to slide within a length of a tube. The push-rod is configured to be coupled to the piston and to be manipulated to cause the piston to slide within the length of tube. The piston includes a plurality of apertures sized to allow passage of particulate matter through the piston within the tube.

The piston can have a resilient peripheral edge configured to provide a seal against an inside surface of the tube.

The piston can be formed of a rigid material, and the beverage strainer can also include a resilient seal coupled to the peripheral edge of the piston. The seal, for example, can include silicone.

The plurality of apertures can be arranged in a grid. For example, the grid can form a screen.

The piston can include a frame, and a filter component including the plurality of apertures and configured to couple to the frame.

The piston can include a frame, a first filter component including a first portion of the plurality of apertures and configured to couple to the frame, and a second filter component including a second portion of the plurality of apertures and configured to couple to the frame.

A size of apertures of the first portion of the plurality of apertures can be different than a size of apertures of the second portion of the plurality of apertures.

The push-rod can be attached to the piston, for example, at a center of a face of the piston.

The beverage strainer can also include a handle attached to the push-rod.

The beverage strainer can also include a collar configured to couple to an end of the tube and to receive the piston. The collar can include a spout.

The beverage strainer can also include a lid configured to cover the collar. The lid can include an opening configured to receive the push-rod.

The beverage strainer can also include a cover configured to cover an end of the tube. The cover can include an impeller, which can include, for example, mixing blades.

According to another aspect of the invention, a beverage strainer includes a piston and a push-rod. The piston is configured to slide along an inner sidewall of a container. The push-rod is configured to be coupled to the piston and to be manipulated to cause the piston to slide along the sidewall. The piston includes a plurality of apertures sized to allow passage of particulate matter through the piston within the container.

The beverage strainer can also include the container and a collar. The container includes the sidewall, an open end, and a closed end. The collar is configured to couple to the open end of the container and to receive the piston.

### BRIEF DESCRIPTION OF THE DRAWINGS

FIG. 1 is a schematic illustration, sideview, of an exemplary beverage strainer according to the invention.

FIG. 2 is a schematic illustration, top view, of an exemplary piston according to the invention.

FIG. 3 is a schematic illustration, cross-sectional side view, of an exemplary beverage strainer according to the invention, inserted within a tube.

FIG. 4 is a schematic illustration of an exemplary beverage strainer according to the invention, cross-sectional view, showing a seal around the piston.

FIG. 5 is a schematic illustration of an exemplary beverage strainer according to the invention, cross-sectional view, showing a filter component inserted within a piston frame.

FIG. 6 is a schematic illustration of an exemplary beverage strainer according to the invention, cross-sectional view, showing a collar and cover.

FIG. 7 is a schematic illustration of an exemplary beverage strainer according to the invention, top view, showing a piston having a drink-mixing impeller.

FIG. 8 is a schematic illustration of an exemplary beverage strainer according to the invention, side view, showing a piston having a blender blade impeller.

FIG. 9 is a schematic illustration of an exemplary beverage strainer according to the invention, cross-sectional view, inserted within a container.

### DETAILED DESCRIPTION OF THE INVENTION

The invention is a container assembly that can be used to blend, shake, infuse, dispense, and drink a beverage. The invention can be embodied as a blender, as an accessory for a blender, or as a universal container assembly. The following exemplary embodiments, and combinations of the elements thereof, are contemplated as being encompassed by the scope of the invention as set forth in more detail below.

For example, the invention blender can be a container that includes a piston or plunger that is configured to remove the pulp from a blended beverage. The plunger assembly couples to the cap or upper collar of the blender container, or includes a collar that couples to the open end of the blender container, and is used to separate and isolate the pulp from the liquid beverage, which can then be dispensed or drunk from the container. The pulp can then easily be removed when the container is cleaned.

A typical blender includes a base unit and a container. The container includes a blade assembly mounted in the bottom of the container, which includes blades rotatable within the container and is coupled at a seal to prevent leakage from the container. The base unit includes a motor used to rotate the blades, and controls for the motor, and is typically powered via AC power or one or more batteries. The portion of the blade assembly arranged outside of the container includes first mating elements that couple with second mating elements coupled to the motor in the base unit. When the respective mating elements are coupled together by seating the container on the base unit, the motor can be controlled to rotate the blades within the container. When ingredients such as fruits are placed in the blender along with water or other liquid and the blades are rotated, the blades cut and blend the contents close to the rotating blades. Through selective design of the blades and with enough speed of rotation, contents of the container are sucked toward the blades as the contents are chopped, and over time the contents are completely liquified and blended.

When the blending is finished, the ingredients are more or less uniformly mixed within the container, with the pulp suspended throughout the beverage, which can be quite thick depending on the beverage ingredients. The container is removed from the base unit so that the beverage can be dispensed. Alternatively, the beverage can be drunk directly from the container.

According to the invention, the blender also includes a plunger assembly that is couplable at the open end of the blender container. The plunger assembly includes a piston, a rod, and a handle. The piston includes a plate having one or more apertures. The rod, which is made of metal or other rigid material, is attached or removably coupled at one end to one face of the plate, and the handle is attached to the other end of the rod. Preferably, the rod couples to the plate at a point that is generally central to the plate, but this is not necessary and the rod can couple to the plate at any point on the plate. The plate is placed within the container above the beverage, with the plane of the plate roughly perpendicular to the sides of the container. Grasping the handle, a user pushes down on the rod to move the plate into contact with the top surface of the beverage. By continuing to apply steady pressure against the counter-pressure of the beverage, liquid is forced through the apertures and above the plate, along with any particulate matter small enough to fit through the aperture. As the handle is pressed downward, more liquid is forced upward until all pulp and particulate matter larger than the aperture is compacted at the bottom of the blender, and the liquid portion of the beverage is contained above the plate. The liquid portion of the beverage can now be dispensed or drunk directly from the container.

The piston preferably also includes a gasket or other seal arranged around the periphery of the plate. The gasket is made of a resilient, preferably food-grade material such as silicone or a similar polymer. The gasket is arranged around the periphery of the plate, such as by having an inner groove into which the plate fits and which contracts to hold the gasket in place. The outer surface of the gasket maintains close contact with the inner sidewall of the blender container, providing a seal so that liquid from the beverage can only pass through the apertures when the plate is pushed against the pressure of the beverage. Alternatively, the plate can be made of silicone or other rigid but resilient material, thinner at the periphery to act as a seal, or can be made of a rigid material that is encased in the resilient material, which extends beyond the edges of the plate to form the seal.

The cross-section of the container can be round or any other shape matching the shape of the periphery of the piston, and at least an upper portion of the container is preferably cylindrical, that is, has parallel sidewall surfaces, and the piston is preferably round or otherwise corresponds to the shape of the container along the length of the sidewall. The cross-section of the container can have any shape as long as the piston has a generally corresponding shape and the gasket seals off the contact between the piston and the container sidewall. Even if the sidewall of the container is not cylindrical and tapers or otherwise modulates over the length of the container, careful selection of the material, shape, and thickness of the gasket can result in a reliable seal along the length of the sidewall as the piston moves along the sidewall. For example, the edge of the gasket can be made thin enough to bend or flex in any places that the width of the container narrows as the plate is pushed through the material in the container. Preferably, the container includes an inner peripheral edge, stop points, or other structure that is arranged so as to prevent the plunger from being moved within reach of the blender blades. This will protect against damage in case the blender motor is actuated accidentally, or if it is desired to assist the blending function by pushing the plunger while blending.

The rod can be fixed to the plate, or can be removably coupled to the plate. If the rod is removably coupled to the plate, the rod can be uncoupled and removed from the container after pressing is complete, for convenience when dispensing or drinking the beverage. The handle can be made of any suitable material, such as plastic or wood, and can assume any suitable shape. For example, the handle can be spherical, and can be smooth or textured. Alternatively, the handle can be a straight bar, or can be L-shaped away from a pouring spout of the container.

Further, a number of different plates can be provided, each of which has different sized apertures and any of which can be coupled to the rod for use in pressing a beverage. If a beverage that is mostly free of pulp is desired, the plate having the smallest apertures can be selected to be coupled to the rod and to be used to press the beverage. If a somewhat pulpy beverage is desired, a plate with larger apertures can be selected. A number of plates featuring a range of aperture sizes provide a variety of pulpiness options for a user pressing a blended beverage using the invention. Rather than providing a number of plates, overlapping plates having apertures can be provided which, when rotated with respect to each other, provide apertures of selectable varying sizes where the respective apertures overlap.

As described, the blender can include the plunger assembly, coupled to the top of the blender at, for example, a cap or collar of the blender. Preferably, a collar holds the plunger assembly in place and couples to the container opening (such as by a threaded, friction-fit, or snap-fit coupler), and a cap covers the collar, with a through-hole in the cap allowing the rod to pass through to the handle above the cap. The collar can also include a pour spout for the container. The collar can include a stop tab or other impediment that prevents the piston from being fully withdrawn from the container unless the tab is released using a spring mechanism or the like. Likewise, a tab or other impediment can be provided as a way to hold the piston at the top of the container when not being used. This tab can also be released when desired, for example, when the user wants to press a beverage.

A pressure release valve can also be included as an element of the invention. When numerous ingredients are blended, particularly at high speed, a physical or even chemical reaction can take place that increases the pressure within the blender. If the blender container is sealed during the blending process, the pressure can reach a level at which the blending or liquification process is hindered, or at which the release of pressure when attempting to dispense the beverage results in a violent outburst of the beverage from the container, resulting in a mess or even injury to the user. The valve can be located anywhere on the container itself, or on the cap, collar, or other suitable place that is in fluid communication with the interior of the container. The valve can be a typical mechanical valve, rated to open upon experiencing a pressure within the container above a selected threshold. Alternatively, the valve can be a simple plug, such as a silicone plug, fitted in a through-hole that is in fluid communication with the interior of the container. The plug can be friction-fitted in the through-hole, or held in place by a notch, flange, or similar element, the release of which is rated for a selected pressure. If the threshold pressure is reached within the container, the plug is expelled from the through-hole in order to relieve the pressure. So as not to lose the plug when expelled, and to avoid injury caused by the expelled plug, the plug can be tethered to an appropriate place on the blender. Alternatively, a second element can be fitted around the periphery of the through-hole, forming a cage external to the blender that catches the plug when expelled.

It is apparent that the plunger assembly can also be fitted to any blender, and therefore the plunger assembly by itself is considered to be an embodiment of the invention. An adapter collar fitted to the plunger assembly and configured to adapt the plunger assembly for use with a standard blender can be provided, making the invention a universal accessory for blenders in general. The assembly can include gaskets of several sizes also, so that a gasket of an appropriate size can be fitted to the piston to adapt to the container of a particular blender with which the plunger assembly is used.

The invention has been described as part of, or for use with, conventional blenders with open-ended containers sitting atop a base unit. In this configuration, the plunger assembly can be arranged above the container while blending takes place, and can be used immediately afterward if desired, with the container removed from the base unit or while the container in still coupled to the base unit (with the motor turned off). However, “bullet-style” blenders operate in a different manner. These types of blenders have a closed-bottomed container that is filled with beverage material such as fruit and liquid, and the blade assembly is coupled on top of the container, usually by screwing the blade assembly in place, sealing the container top. The container is then inverted before coupling to the base unit and operating the motor to liquify the ingredients and blend the beverage. After the beverage is blended, the container is removed from the base unit and returned to its original orientation with the blade assembly atop the container, and the blade assembly is decoupled from the container opening. The beverage can then be dispensed or drunk.

For this type of blender arrangement, it would not be practical to have the plunger assembly in place during the blending operation. In this case, the plunger assembly can be coupled to the container after the blade assembly has been decoupled from the container. The plunger assembly can be provided within a collar that can couple to the container, such as by being screwed into place at the open end of the container. The plunger assembly can then be used as described above to remove pulp from the beverage to the extent desired. In such a blender, the pressure release valve can be located on the closed end of the container, which is oriented in an upward position during blending. So that the container can be stood on end when inverted for pressing, the valve can be located in a recessed portion of the closed end of the container. For example, the container can include a recess much like the punt of a wine bottle, in which the valve can be arranged.

In any embodiment, once the beverage has been pressed and dispensed or drunk, the compressed pulp at the bottom of the container can be easily removed and disposed of. The container can then be cleaned as it otherwise would be as part of a conventional blending procedure, and the plunger assembly is easy to clean as well.

Beverage material such as fruit, vegetables, and water or other liquid have been described for use with the invention, but it will be apparent that any other type of typical blended beverage ingredient, such as protein powder, collagen, MCT oil, or any other supplement or flavoring can be used with the invention as a beverage ingredient. Even coffee grounds or other ingredients from which a beverage is usually extracted but which is typically filtered from the beverage before drinking can be used as a beverage ingredient using the plunger assembly, which will leave the extraction in the beverage but remove and compact the grounds with the pulp.

Further, the invention can encompass any type of container, or can be embodied as an accessory for any type of container. For example, a shaker cup can incorporate the plunger assembly of the invention, separating any solid matter from a beverage after the beverage ingredients have been shaken to mix the beverage. Even a simple water bottle can incorporate the plunger assembly, for example to infuse flavors or other essences into a beverage, Ingredients such as lemon or other fruits, ginger, medicinal herbs, or other solid matter can be added to a beverage mixture, or to water alone, and pressed with the plunger assembly to infuse the flavor or essence of these ingredients into the beverage or water, leaving the solid matter separated from the resulting beverage by the piston. The use of pressure from the plunger to provide the infusion speeds the infusion process, making possible quick infusion of flavors and essences directly from fruit and other real food instead of from powders or other processed materials.

Carbonated liquid such as seltzer, club soda, and the like can be used to make an infused carbonated beverage, with added ingredients and/or infused flavors. When carbonated liquid is used, it is preferable that the release valve described above be used as well, to avoid the build-up of excess pressure. The plunger assembly can also be used with home soda-making machines, allowing the flavoring of the soda using wholesome fruit and natural essences rather than chemicals or flavoring powders.

In general, the invention can be a container that is open on both ends, that is, a tube. Preferably the tube is cylindrical, but a cylindrical shape is not necessary. Each end of the tube can include a mating element, such as a threaded, friction-fit, or snap-fit element, configured to couple with a corresponding mating element of a container end-piece. Different end-pieces can be selected to suit the desired application for the container. For example, end-pieces can include a blender end, a cap end, a shaker end, and a plunger end. The blender end can couple with one end of the tube and can include blender blades that are arranged in the interior of the tube when the blender end is mated with the tube, and elements on the outside of the tube that can mate with corresponding elements of a blender base unit. A cap end can be coupled to the other end of the tube when blending a beverage in the tube, to be replaced by a plunger end after blending, so that the pulp can be pressed from the beverage. With the rod removed, a cap end can be placed back on the tube for transport of the beverage, or the beverage can be dispensed or drunk right away. A shaker end can be used instead of a blender end for beverages that are to be made from powdered ingredients, and the plunger end can be used to add infusions. This embodiment is a modular container assembly that can be used to blend, mix, shake, infuse, store, transport, dispense, and drink a beverage as desired.

Thus, the invention includes a blender, or an accessory for a blender, that is configured to separate the liquid of a blended beverage from the pulpy or particulate mass of the beverage, completely or to the extent desired by a user, in a manner that allows for convenient use after blending, and for convenient dispensing and drinking after pressing. The invention also includes a shaker bottle, drink bottle, infuser, juicer, and modular container assembly, providing flexibility in preparing and serving beverages.

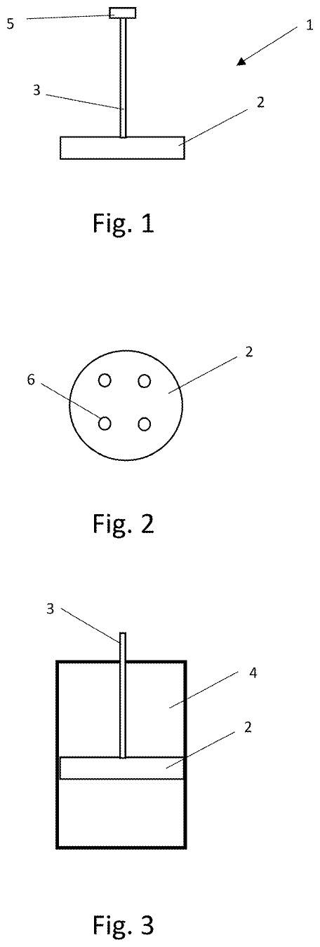

Referring to FIG. 1, in general, the invention is a dynamic beverage strainer 1 that includes a piston 2 and a push-rod 3. Referring to FIG. 3, the piston 2 is configured to slide within a length of a tube 4. For example, the tube 4 can be part of a container that holds a beverage in which pulp, grounds, or other particulate matter is suspended, and the piston 2 can slide within the container along the sidewall. The piston 2 can take any shape, but generally separates two interior regions of the tube 4 when in the tube 4, defines the border between the regions of the tube 4, and moves along the length of the tube 4. Presumably, the tube 4 has substantially parallel interior sides and a cross-section of any shape, with the piston 2 having a generally corresponding cross-sectional shape.

The push-rod 3 is a rigid elongated member that is configured to be coupled to the piston 2 and to be manipulated to cause the piston 2 to slide within the length of tube 4. That is, because of its connection to the piston 2, pushing and pulling the push-rod 3 causes corresponding movement of the piston 2. Typically, the push-rod 3 will be manipulated by hand (directly or by hand-crank) to move the piston 2, but a motorized mechanism can be connected to move the push-rod 3 and piston 2. For hand manipulation by a user, an ergonomic or decorative handle 5 can be attached to the free end of the push-rod 3. The push-rod 3 can couple with the piston 2 at a point on a face of the piston 2, preferably but not necessarily at or near a center of the face of the piston 2. Any manner of coupling the push-rod 3 to the piston 2 is contemplated, including a threaded screw-in connection, a snap-fit connection, or a friction-fit connection. Preferably, the push-rod 3 is removably coupled to the piston 2, but it can be fixed to the piston 2 instead.

Referring to FIG. 2, the piston 2 includes a plurality of apertures 6 sized to allow passage of particulate matter through the piston 2 within the tube 4. That is, as the piston 2 is moved through liquid in the tube 4, particulate matter too large to fit through the apertures 6 will collect at the leading face of the piston 2 and will be trapped in the region of the tube 4 on that side of the piston 2, allowing strained liquid into the region of the tube 4 at the trailing edge of the piston 2. The strained liquid will only have particulate matter that was small enough to fit through the apertures 6 in the piston 2. In the case of a strained beverage, this can be dispensed from the tube 4 for drinking, or can be drunk directly from the tube 4. In an exemplary embodiment, the push-rod 3 can be a hollow, rigid tube, such as a metal tube, with a central channel that opens at some point in the sidewall before the point at which it couples with the piston 2. In this embodiment, the push-rod 3 can be used as a straw to drink the strained beverage from the tube 4.

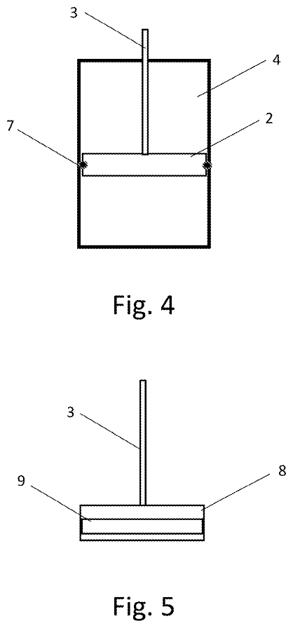

To function effectively, the piston 2 should make close contact with the inner wall of the tube 4, while still being able to move along the inner wall. There are several ways in which this can be accomplished. For example, the piston 2 can have a resilient peripheral edge configured to provide a seal against the inside surface of the tube 4. Alternatively, the piston 2 can be formed of a rigid material, and the beverage strainer 1 can also include a resilient seal member coupled to the peripheral edge of the piston 2. The seal member, for example, can include silicone or other food-grade polymer that is flexible but strong, so as to press against the tube 4 but not resist movement along the tube 4. For example, the piston 2 can be formed from silicone that thins toward the edges for flexibility against the tube 4. Alternatively, the piston 2 can be formed from metal or hard plastic base that is coated with silicone so as to provide a flexible silicone peripheral edge. As another alternative, a sealing element can be coupled to the periphery of a rigid piston 2. For example, the piston 2 can have a recessed channel in the outer periphery, into which a flexible O-ring 7 or the like can be inserted, as shown in FIG. 4.

The apertures 6 can be arranged in the piston 2 in any manner that is practical. For example, the apertures 6 can be arranged in a regular pattern such as a grid, which can form a screen, or can be arranged in any other pattern, or randomly, or in any other fashion. The apertures 6 can be simple through-holes flush with the surface of the face of the piston 2, or can have raised and/or sunken edges so as to affect fluid flow at the apertures 6.

The piston 2, or base of the piston 2, can be formed from a single piece of material with the apertures 6 formed in the material. Alternatively, referring to FIG. 5, the piston 2 can include a frame 8, and a separate filter component 9 including the apertures 6 and configured to couple to the frame. In this case, several filter components 9 can be provided, each of which has different sized apertures 6. Based on the degree to which a user wants to strain the beverage, a filter component 9 having appropriately-sized apertures 6 is selected and coupled to the piston 2 frame 8 for use in straining the beverage. If desired, multiple filter components 9 can be coupled to the frame 8 to be used together, either in contact with each other or spaced apart. These can be arranged to provide custom levels of filtering based on the filter profile of the combination of filters. Filter components 9 arranged in descending order of aperture size can also provide stages of filtering within the piston 2, with each successive filter component 9 trapping a different range of size of particulate matter. The frame 8 can form a base with which one or more of the filter components 9 can couple. For example, the frame 8 can include the outer periphery of the piston 2, and the filter components 9 can be coupled as inserts to the outer frame 8. The frame 8 and the filter components 9 can have cooperating features that enable coupling, such as mating threads, snap-fit elements, or clips.

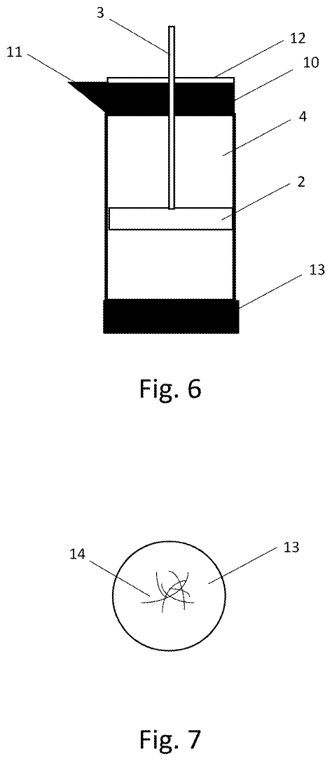

Referring to FIG. 6, in order to couple to an end of the tube 4, the beverage strainer 1 can also include a collar 10, which can include a cooperating feature such as screw threads or a snap-fit mating element to enable coupling with the end of the tube 4. The collar 10 can also be configured to receive the piston 2, and to releasably hold the piston 2 in place prior to being put to use. The collar 10 can include a spout 11 to facilitate pouring a beverage from the tube 4. The beverage strainer 1 can also include a lid 12 configured to cover the collar 10 to avoid splashing of the contents of the tube 4 during blending or straining. The lid 12 can include an opening configured to receive and accommodate the push-rod 3 so that the push-rod 3 can be manipulated to strain a beverage while the lid 12 is in place on the collar 10.

The beverage strainer 1 can also include a cover 13 configured to cover an end of the tube 4, preferably the end toward which the piston 2 would be pushed to strain the beverage. The cover 13 and the end of the tube 4 can include cooperating coupling elements to secure the cover 13 in place. For example, both can be threaded, or both can include snap-fit or friction fit elements. The cover 13 and/or the tube 4 can include sealing elements, or a gasket can be coupled between the cover 13 and the tube 4, so that the cover 13 can provide a fluid-tight seal. Thus, with the cover 13 in place, the tube 4 can function as a container for the beverage, from which the beverage can be dispensed or drunk directly. The cover 13 can also function as a base on which the beverage strainer 1 stand when placed on a stable surface.

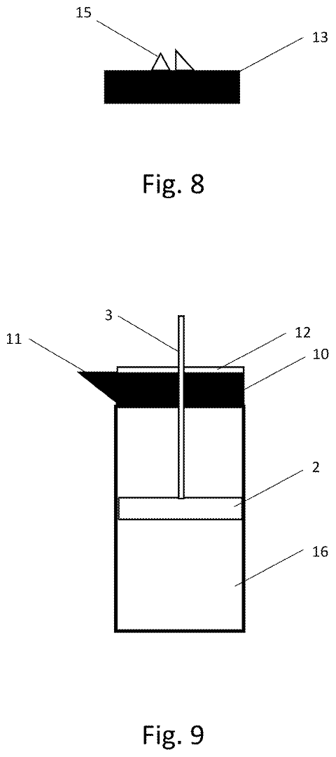

The cover 13 can include features that make the tube 4 suitable for mixing beverages when coupled with the tube 4. For example, the cover 13 can include an impeller. Referring to FIG. 7, this impeller can be static, such as a projecting structure 14 that is configured to break up drink mix powder when shaken with a liquid within the tube 4. Alternatively, the impeller can have a dynamic element. For example, referring to FIG. 8, the impeller can include rotating or otherwise movable mixing blades 15, such as those included as part of the container of a typical electric blender. In this case, the cover 13 can also include structure outward of the tube 4 configured to seat on the motorized base of the blender to engage the mixing blades. In either case, a similarly sealing cover can be coupled to the other end of the tube 4 before shaking or blending, or the collar lid 12 described above can be made to similarly seal to the collar 10.

As described, the invention can be embodied as a modular beverage-straining system. In addition to the essential elements of the piston 2 and the push-rod 3, the system can include any or all of the tube 4, one or more covers 13, the collar 10, and the collar lid 12. The one or more covers 13 can include plain covers 13 having no mixing function, covers 13 with passive impellers, and covers 13 having dynamic impellers. The piston 2 can be a have a fixed arrangement of apertures 6, or can include a frame 8 and several filter components 9 for selectable levels of beverage straining. The modular components can be assembled in various combination suitable for different uses. For example, the passive cover 13 can be coupled to a first end of the tube 4, liquid and shakable beverage components can be added to the tube 4, and a plain cover 13 coupled to the second end of the tube 4. The beverage can then be shaken, either cover 13 removed, and the beverage strained using the piston 2, with or without using the collar 10. The strained beverage can then be dispensed or drunk directly from the tube 4. Alternatively, the push-rod 3 can be de-coupled from the piston 2 and a cover 13 coupled to the open end of the tube 4 so that the strained beverage can be transported for future consumption. The system can likewise be assembled for use with a blender, such that the blended beverage can be strained and then dispensed, drunk, or transported. Even a purchased, prepared drink such as fruit juice can be poured into the tube 4 and strained if the prepared drink has too much pulp to suit the user. The system can also be used without mixing or blending in order to speed the time of infusion of a beverage, such as a fruit drink or tea, by the added pressure provided by the piston on the infusion liquid.

Of course, the invention can also be embodied to be less modular, such that the beverage strainer 1 includes a piston 2 and a push-rod 3, with the piston 2 is configured to slide along inner sidewall of a container 16. Referring to FIG. 9, the push-rod 3 in this case is configured to be coupled to the piston 2 and to be manipulated to cause the piston 2 to slide along the sidewall of the container 16. As with the more modular embodiment described above, the piston 2 includes a plurality of apertures 6 sized to allow passage of particulate matter through the piston 2 within the container 16. This embodiment of the beverage strainer 1 can also include the container 16 and the collar 10. The container 16 includes the sidewall, an open end, and a closed end. The collar 10 is configured to couple to the open end of the container 16 and to receive the piston 2, similarly to the arrangement described above. The container 16 can include passive or dynamic impeller elements, and the piston 2 can have fixed or selectable apertures 6 or combinations of apertures 6.

The present invention has been described by way of example and in terms of preferred embodiments. However, the present invention as contemplated by the inventor is not strictly limited to the particularly disclosed embodiments. To the contrary, various modifications, as well as similar arrangements, are included within the spirit and scope of the present invention. The invention, therefore, should be accorded the broadest reasonable interpretation so as to encompass all such modifications and similar arrangements.

I claim:

1. A beverage strainer, comprising:
a piston, configured to slide within a length of a tube; and
a push-rod, configured to be coupled to the piston and to be manipulated to cause the piston to slide within the length of tube;
wherein the piston includes a plurality of apertures sized to allow passage of particulate matter through the piston within the tube.

2. The beverage strainer of claim 1, wherein the piston has a resilient peripheral edge configured to provide a seal against an inside surface of the tube.

3. The beverage strainer of claim 1, wherein the piston is formed of a rigid material, the beverage strainer further comprising a resilient seal coupled to the peripheral edge of the piston.

4. The beverage strainer of claim 3, wherein the seal includes silicone.

5. The beverage strainer of claim 1, wherein the plurality of apertures are arranged in a grid.

6. The beverage strainer of claim 5, wherein the grid forms a screen.

7. The beverage strainer of claim 1, wherein the piston includes:
a frame; and
a filter component including the plurality of apertures and configured to couple to the frame.

8. The beverage strainer of claim 1, wherein the piston includes:
a frame;
a first filter component including a first portion of the plurality of apertures and configured to couple to the frame; and
a second filter component including a second portion of the plurality of apertures and configured to couple to the frame.

9. The beverage strainer of claim 1, wherein a size of apertures of the first portion of the plurality of apertures is different than a size of apertures of the second portion of the plurality of apertures.

10. The beverage strainer of claim 1, wherein the push-rod is attached to the piston.

11. The beverage strainer of claim 10, wherein the push-rod is attached to the piston at a center of a face of the piston.

12. The beverage strainer of claim 1, further including a handle attached to the push-rod.

13. The beverage strainer of claim 1, further including a collar configured to couple to an end of the tube and to receive the piston.

14. The beverage strainer of claim 13, wherein the collar includes a spout.

15. The beverage strainer of claim 1, further comprising a lid configured to cover the collar, wherein the lid includes an opening configured to receive the push-rod.

16. The beverage strainer of claim 1, further comprising a cover configured to cover an end of the tube.

17. The beverage strainer of claim 16, wherein the cover includes an impeller.

18. The beverage strainer of claim 17, wherein the impeller includes mixing blades.

19. A beverage strainer, comprising:
a piston, configured to slide along an inner sidewall of a container; and
a push-rod, configured to be coupled to the piston and to be manipulated to cause the piston to slide along the sidewall;
wherein the piston includes a plurality of apertures sized to allow passage of particulate matter through the piston within the container.

20. The beverage strainer of claim 19, further comprising:
the container, including the sidewall, an open end, and a closed end; and
a collar configured to couple to the open end of the container and to receive the piston.
